(19) United States
(12) Patent Application Publication
(10) Pub. No.: US 2010/0264651 A1
(43) Pub. Date: Oct. 21, 2010

(54) Sealing Element and Plug Connection with Reduced Joining Resistance

(75) Inventors: Erhard Flach, Berlin (DE); Ronald Rebentisch, Berlin (DE)

Correspondence Address: BUCHANAN INGERSOLL & ROONEY PC, P.O. BOX 1404, ALEXANDRIA, VA, 22313-1404, US

(73) Assignee: BIOTRONIK CRM PATENT AG, Baar (CH)

(21) Appl. No.: 12/759,750

(22) Filed: Apr. 14, 2010

(30) Foreign Application Priority Data
Apr. 15, 2009 (DE) 10 2009 002 398.4

(51) Int. Cl. F16L 21/035; F16J 15/10; F16L 21/02; F16L 21/03

(52) U.S. Cl. 285/351; 277/626; 285/374

(57) ABSTRACT

A plug connection, including a plug connector and a socket for an implantable medical device, and further including a sealing element which is sheared along the axis of the plug connector and which seals the lumen formed by the socket and the proximal end of the plug connector against the environment.

### CROSS-REFERENCE TO RELATED APPLICATIONS

This application claims the priority of German Patent Application No. DE 10 2009 002 398.4, filed on Apr. 15, 2009 in the German Patent Office, the disclosure of which is incorporated herein in its entirety by reference.

### FIELD OF THE INVENTION

The present invention relates to a sealing element and a plug connection with a sealing element which can be used on or in an implanted medical device (“IMD”) and which has a reduced mechanical joining resistance when joining plug connector and socket.

### BACKGROUND OF THE INVENTION

Known sealing elements and plug connections have the disadvantage that peak forces occur when joining the plug connector and socket and, in particular, when the static friction must be overcome when the sealing element, or the sealing elements, abut against their assigned sealing faces and the frequently occurring required deformation energy for passing the entrance openings of the sealing faces must be applied. In case of the IMDs, such peak forces can cause damage to the plug connector, the socket and/or the lines attached to the plug connector (for example, by bending the line).

In the following, the term “static friction” is to be understood as the static friction and/or the force that is necessary to deform the sealing element. Also, the sealing element is not limited to a simple sealing element, but can relate to the sealing part of a larger structure.

Previous solutions optimize primarily the sealing capability of the sealing elements, typically by minimizing the sealing face, and address the joining only to the extent that outer edges or inner edges of the sealing elements are rounded and/or that friction-reducing additives and/or coatings are used.

The present invention is directed towards overcoming one or more of the above-identified problems.

### SUMMARY OF THE INVENTION

The present invention is intended to provide an optimized sealing element and an optimized plug connection with the sealing element which are optimized with respect to preventing peak forces during joining.

According to the present invention, a sealing element for sealing plug connections of an implanted medical device (“IMD”) is provided, wherein the sealing element has a first expansion in one plane, and a second expansion perpendicular to the plane, and has an opening within this plane, which opening extends over the second expansion, and wherein the sealing element is sheared.

The phrasing “sheared” refers to one or more shearings, and or elongations, and/or displacements of the basic shape. The sealing element can be manufactured in such a manner that it has the sheared shape without application of a force, or that it can be formed into this shape by applying a force. The term “plug connection” includes electrical plug connections as well as plug connection for hollow lines, such as, for example, for liquids.

Furthermore, the sealing element can be sheared in such a manner that a segment of the sheared sealing element runs parallel to the second expansion. In a preferred embodiment, the sealing element can have the shape of a sealing ring which is sheared parallel to a second expansion.

In a further preferred embodiment, the sealing element consists of an elastic material with a Shore hardness between 15 ShA and 80 ShA, according to DIN 53505 and DIN 7868.

In a particularly preferred embodiment, the sealing element consists of an elastomer and/or polymer, preferably from silicone rubber or latex, polyurethane, or polyurethane-copolymer with silicone content.

In a further preferred embodiment, the sealing element is provided with a hydrophobic and/or hydrophilic coating for reducing the sliding friction.

In addition, according to the present invention, a plug connection for an IMD is provided, including a plug connector and a socket with a sheared sealing element which seals a lumen formed by the socket and the proximal end of the plug connector against the environment. The sealing element can be designed according to any one of the above described embodiments.

In a preferred embodiment, the sealing element can sit on the plug connector or within the socket in a recess which is suitable to receive the sealing partially and to securely locate it on the plug connector or within the socket. Alternatively, the sealing element can also be part of a larger element, and the larger element securely locates the sealing element on the plug connector or within the socket. In addition, the plug connection can be designed in such a manner that a segment of the sheared sealing element runs parallel to the longitudinal axis of the plug connector.

In a particularly preferred embodiment, the plug connector has a cylindrical shape and the sheared sealing element has the shape of a sheared sealing ring. In a further particularly preferred embodiment, the plug connection has two or more sealing elements which are sheared along the axis of the plug connection and which seal the lumen formed by the socket and the proximal end of the plug connector and the lumen, or the lumens, between the sealing elements against the environment. It is also preferred that the plug connection has two or more sealing elements, wherein the position of the sealing elements on the plug connector or within the socket is configured in such a manner that the sealing elements, during insertion of the plug connector into the socket, come into contact with their assigned sealing face of the socket or the plug connector with a time difference.

It is particularly preferred that the time difference is configured in such a manner that during joining, a sealing element touches the distal end of its assigned sealing face only when the previously inserted sealing element has completely passed the distal end of its assigned sealing face. Alternately, the time difference can be configured in such a manner that a sealing face of a plug connector touches the distal end of its assigned sealing element only when the previously inserted sealing face has completely passed the proximal end of its assigned sealing element.

Other objects, aspects and advantages of the present invention can be obtained from a study of the specification, the drawings, and the appended claims.

### BRIEF DESCRIPTION OF THE DRAWINGS

Embodiments of the present invention are described in an exemplary manner with reference to the attached drawings. In the Figures:

FIG. 1A shows a side view of a plug connector with two sealing elements known as prior art;

FIG. 1B shows the forces to be overcome when joining a prior art plug connector with respect to the distance covered during joining;

FIG. 2A shows an embodiment according to the invention of a plug connection with a sheared sealing element;

FIG. 2B shows a sheared sealing ring according to the invention;

FIG. 2C shows the forces to be overcome when inserting a plug connector into a socket having a sealing element according to the invention as shown in FIG. 2A with respect to the distance covered during joining;

FIG. 3A shows an embodiment according to the invention of a plug connection with two sheared sealing elements;

FIG. 3B shows the forces to be overcome when joining a plug connector having sealing elements according to the invention as shown in FIG. 3A with respect to the distance covered during joining;

FIG. 4A shows an embodiment according to the invention of a plug connection with a sealing element which is sheared in two areas and elongated in one area;

FIG. 4B shows the forces to be overcome when joining a plug connector having a sealing element according to the invention as shown in FIG. 4A with respect to the distance covered during joining;

FIG. 5A shows an embodiment according to the invention of a plug connection with two sheared sealing elements with different diameters on a plug connector with different diameters;

FIG. 5B shows the forces to be overcome when joining a plug connector having sealing elements according to the invention as shown in FIG. 5A with respect to the distance covered during joining; and

FIG. 6 shows an embodiment according to the invention of a plug connection with two sheared sealing elements with different diameters within a socket with two different diameters.

### DETAILED DESCRIPTION OF THE INVENTION

Provided is a sealing element and a plug connection with at least one sealing element. For illustration purposes only, the sealing elements are shown as sealing rings and the plug connection is shown as a cylindrical plug connector with a cylindrical socket; however, they can also be provided in any other shape such as, but not limited to, sealing disks or polygonal sealing disks, or polygonal sealing rings, or polygonal plug connectors and/or sockets. Also, for a better understanding, the illustration of more than two sealing elements is omitted, wherein it is apparent for a person skilled in the art that, for example, for multi-pole plug connections perhaps more sealing elements may be required.

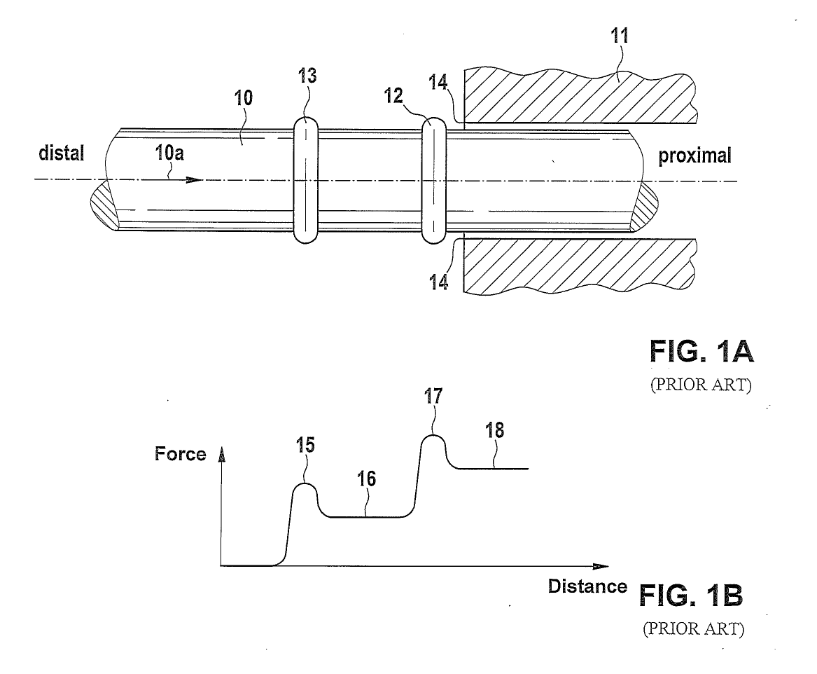

Known from the prior art is a plug connection, as shown in FIG. 1A. In FIG. 1A, two ring seals 12 and 13 are sitting on a plug connector 10. The proximal end of the plug connector is inserted into the socket 11 in direction of arrow 10a. The peak forces to be overcome herein are illustrated in FIG. 1B. The forces to be overcome are plotted against the travel distance of the plug connector 10 within the socket 11. The occurring peak forces 15 and 17 are generated by the static friction to be overcome and by deformation forces which are generated when the sealing elements are pressed into the sealing faces 14 of the socket 11. The drops 16 and 18 are generated due to the disappearance of the forces to be applied for the deformation and due to the disappearance of the static friction after the complete insertion of the respective sealing element 12 or 13 into the sealing faces 14.

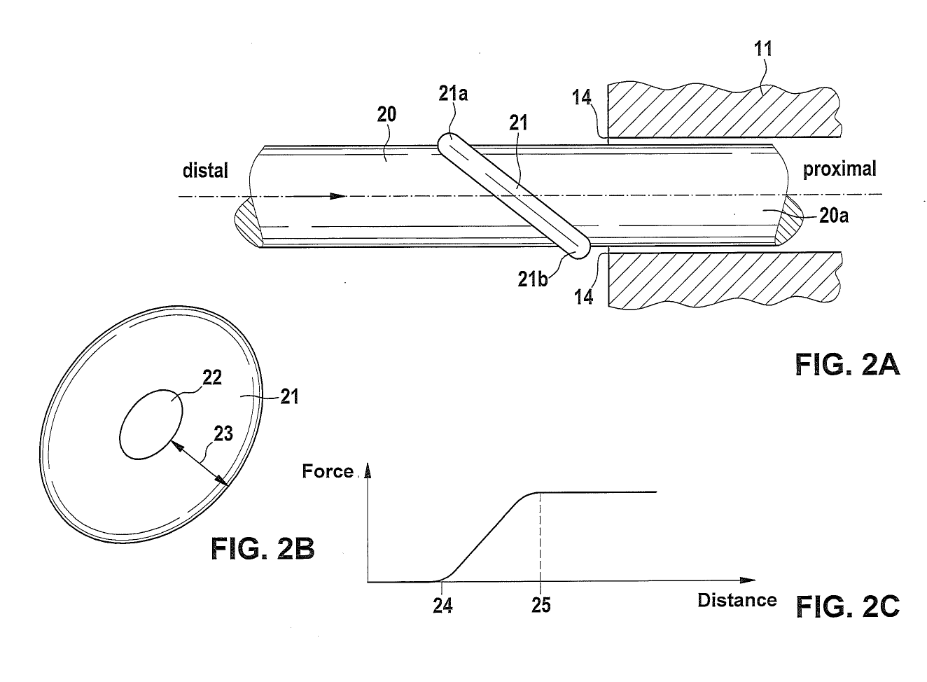

A plug connection according to the present invention with a sealing element according to the invention is shown in FIG. 2A. The plug connector 20 is inserted with the proximal end 20a into the socket 11. The sealing element 21 is sheared along the longitudinal axis of the plug connector 20 in such a manner that first the proximal end of the sealing element 21b touches the sealing face 14 when inserting the proximal end of the plug connector 20a into the socket 11, and that the rest of the sealing element 21a comes in contact with the sealing face 14 only after further insertion, and that the distal end of the sealing element 21a passes the sealing face 14 last.

FIG. 2B shows a sealing element 21 prior to shearing. It has an opening 22, wherein the area of the opening lies in the area of the sealing element and forms an axis perpendicular to the area of the opening, and wherein the sealing element has a constant thickness 23 at a position perpendicular to the opening.

In FIG. 2C, the force to be overcome is plotted against the travel distance of the plug connector 20 into the socket 11, wherein the point 24 indicates the moment when the proximal section of sealing element 21b comes into contact with the sealing face 14, and the point 25 indicates the complete insertion of the distal end of the sealing element 21a into the sealing face 14. Here, through the comparison of FIG. 1B with FIG. 2C, the absence of peak forces in FIG. 2C is easily recognizable.

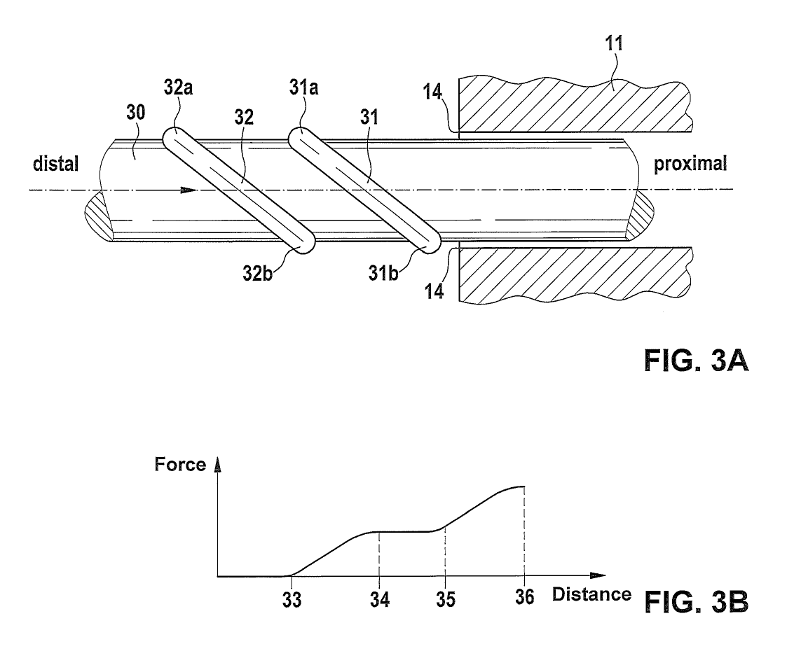

FIG. 3A shows a plug connector 30 with two sheared sealing elements 31 and 32 according to the present invention, and the socket 11 with the distal end of the sealing face 14. In FIG. 3B, the force to be overcome is plotted against the travel distance of the plug connector 30 into the socket 11, wherein point 33 indicates the moment when the proximal section of the proximal sealing element 31b comes into contact with the sealing face 14, point 34 indicates the complete insertion of the distal end of the sealing element 31a into the sealing face 14, point 35 indicates the moment when the proximal section of the distal sealing element 32b comes in contact with the sealing face 14, and point 36 indicates the complete insertion of the distal end of the sealing element 32a into the sealing face 14.

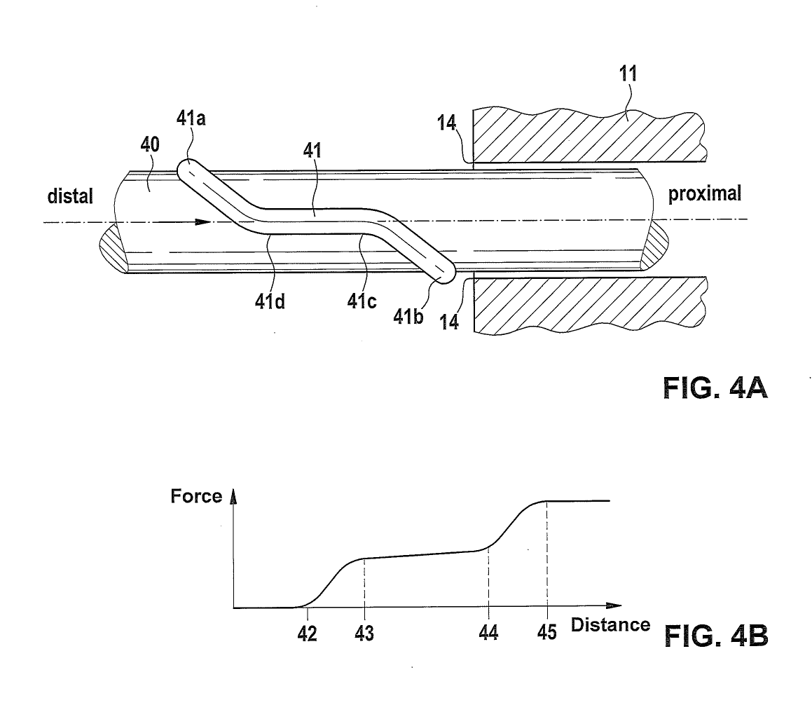

FIG. 4A shows a sheared sealing element 41 according to the invention on a plug connector 40. The sealing element 41 is sheared in the two outer areas and is elongated in the middle area in such a manner that a segment of the sealing element 41 between 41c and 41d runs generally parallel to the axis of the plug connector 40. This arrangement results in the shape of the graph in FIG. 4B in which the force to be overcome is plotted against the travel distance of the plug connector 40 into the socket 11. Point 42 of the graph represents the section of the travel in which the proximal end of the sealing element 41b comes into contact with the sealing face 14, and point 43 marks the transition of the curve of the sealing element 41c in the area in which the sealing element runs generally parallel to the longitudinal axis of the plug connector 40. Point 44 in turn marks the exit of the sealing element's 41 area 41d running generally parallel to the longitudinal axis of the plug connector 40, and point 45 marks the complete insertion of the distal end 41a of the sealing element 41 into the sealing face 14.

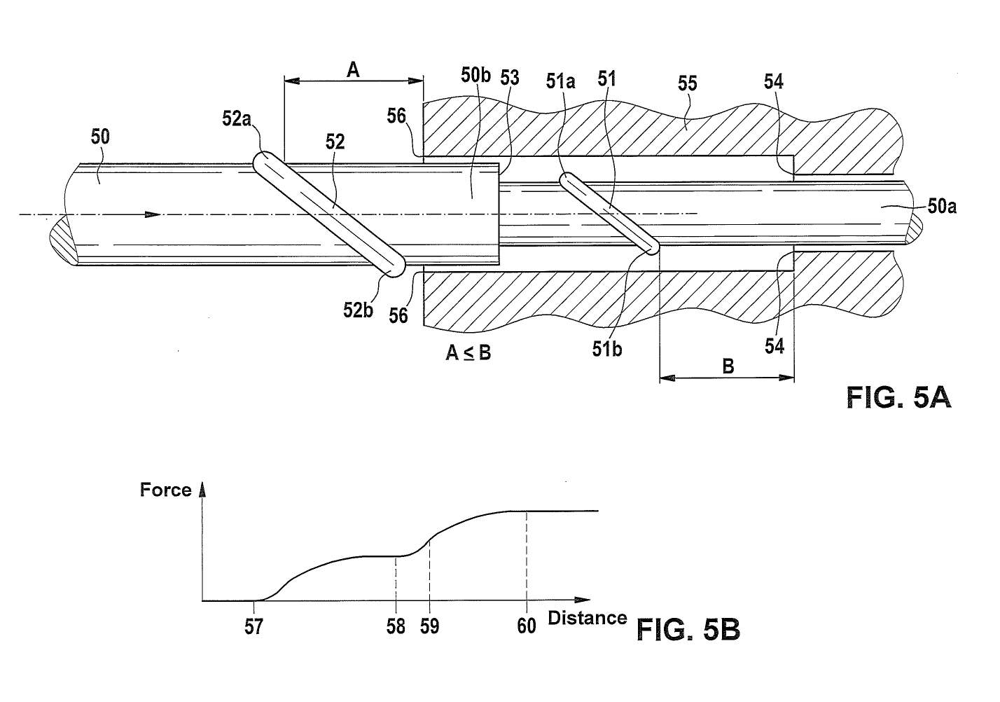

FIG. 5A shows a particularly preferred shape of the plug connector 50 and of the socket 55, wherein the two sealing faces 56 and 54 have different sizes in which the respective proximal plug connector sections 50b and 50a fit. The sealing elements 51 and 52 are arranged on the respective plug connector sections 50a and 50b in such a manner that they touch the respective sealing faces 54 and 56 with their proximal ends 51b and 52b when inserting the plug connector 50 into the socket 55 with a time difference, this means, the distances A and B are selected such that the sealing elements touch their respectively assigned sealing faces at different points in time. Here, in the non-inserted state, the distance B of the proximal end 51b of the sealing element 51 to the distal end of the sealing face 54 is greater than or equal to the distance A of the distal end 52a of the sealing element 52 to the distal end of the sealing face 56.

In FIG. 5B, the force to be overcome is plotted against the travel distance of the plug connector 50 into the socket 55, wherein point 57 indicates the moment when the proximal section of the proximal sealing element 51b comes into contact with the sealing face 54, point 58 indicates the complete insertion of the distal end 51a of the sealing element 51 into the sealing face 54, point 59 indicates the moment when the proximal section of the distal element 52b comes into contact with the sealing face 56, and point 60 indicates the complete insertion of the distal end 52a of the sealing element 52 into the sealing face 56.

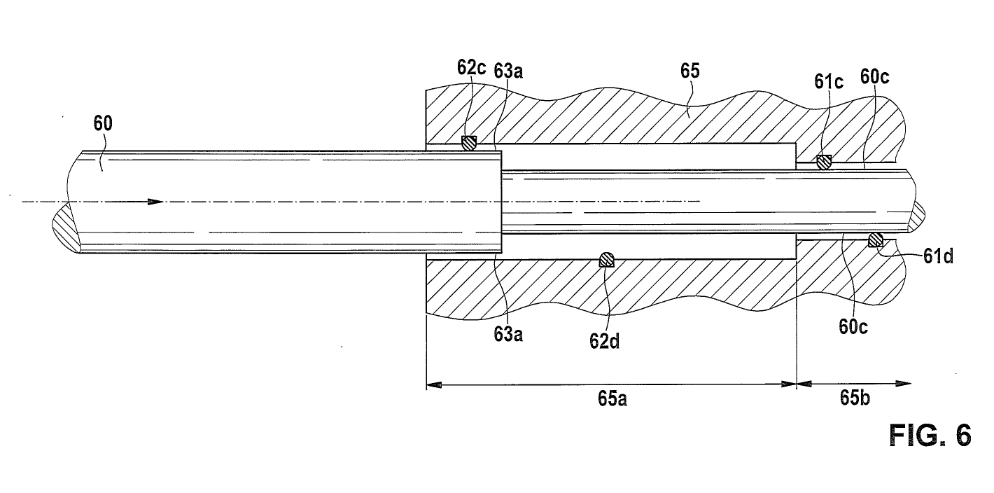

FIG. 6 shows a particularly preferred shape of the plug connector 60 and of the socket 65, wherein the two sealing faces 63a and 60c have different sizes which fit into the respective different sized socket section 65a and 65b. The sealing elements 61 and 62 are shown in FIG. 6 only by means of the sections 61c, 61d and 62c, 62d; however, they run within the respective socket section 65b and 65a in a sheared manner analogous to the sealing elements 51 and 52 on the plug connector 50, as shown and described with respect to of FIG. 5A. The sealing elements 61 and 62 are arranged in the respective socket sections 65b and 65a in such a manner that when inserting the plug connector 60 into the socket 65, the sealing elements 62 and 61 come into contact with the respective sealing faces 63a and 60c with a time difference similar to that previously described, as appreciated by one of ordinary skill in the art.

It will be apparent to those skilled in the art that numerous modifications and variations of the described examples and embodiments are possible in light of the above teachings without departing from the spirit and scope of the present invention. The disclosed examples and embodiments are presented for purposes of illustration only and are not meant to limit the scope of the invention in any way. Therefore, it is the intent to cover all such modifications and alternate embodiments as may come within the true scope of this invention, which is to be given the full breadth of the appended claims and any and all equivalents thereof.

We claim:

1. A sealing element for sealing plug connections of an implantable medical device, wherein the sealing element comprises:
a first expansion in one plane; and
a second expansion perpendicular to the one plane,
wherein the sealing element has an opening which lies in the one plane and extends over the second expansion, and
wherein the sealing element is sheared.

2. The sealing element according to claim 1, wherein a segment of the sheared sealing element runs parallel to the second expansion.

3. The sealing element according to claim 1, wherein the sealing element has the shape of a sealing ring which is sheared parallel to the second expansion.

4. The sealing element according to claim 1, wherein the sealing element comprises an elastic material with a Shore hardness between 15 ShA and 80 ShA.

5. The sealing element according to claim 1, wherein the sealing element comprises an elastomer and/or polymer material.

6. The sealing element according to claim 5, wherein the elastomer and/or polymer material comprises silicone rubber or latex, polyurethane or polyurethane-copolymer with silicone content.

7. The sealing element according to claim 1, wherein the sealing element includes a hydrophobic and/or a hydrophilic coating for reduction of sliding friction.

8. A plug connection for an implantable medical device, comprising:
a plug connector;
a socket for receiving the plug connector; and
a sealing element, wherein the sealing element comprises:
a first expansion in one plane; and
a second expansion perpendicular to the one plane,
wherein the sealing element has an opening which lies in the one plane and extends over the second expansion, and
wherein the sealing element is sheared,
wherein the sheared sealing element seals a lumen formed by the socket and a proximal end of the plug connector against the environment.

9. The plug connection according to claim 8, wherein the sealing element is provided on the plug connector or within the socket in a recess which is configured to partially receive the sealing element and to securely locate it on the plug connector or within the socket.

10. The plug connection according to claim 8, wherein the sealing element is part of a larger element on the plug connector or in the socket, and wherein the larger element securely locates the sealing element on the plug connector or in the socket.

11. The plug connection according to claim 8, wherein a segment of the sheared sealing element runs parallel to a longitudinal axis of the plug connector.

12. The plug connector according to claim 8, wherein the plug connector has a cylindrical shape and the sheared sealing element has a shape of a sheared sealing ring.

13. The plug connection according to claim 8, wherein the sheared sealing element comprises two or more sheared sealing elements.

14. The plug connection according to claim 13, wherein the two or more sealing elements are arranged in such a manner that when inserting the plug connector into the socket, the two or more sealing elements come into contact with their respective assigned sealing faces of the socket or of the plug connector with a time difference.

15. The plug connection according to claim 14, wherein the time difference is configured in such a manner that a sealing element touches a distal end of its respective assigned sealing face during insertion only when a previously inserted sealing element has completely passed a distal end of its respective assigned sealing face.

16. The plug connection according to claim 14, wherein the time difference is configured in such a manner that a sealing face of a plug connector touches a distal end of its respective assigned sealing element only when a previously inserted sealing face has completely passed a proximal end of its respective assigned sealing element.
